(19) United States
(12) Patent Application Publication
(10) Pub. No.: US 2011/0036196 A1
(43) Pub. Date: Feb. 17, 2011

(54) ELECTRONIC THROTTLE CONTROL DEVICE FOR MOTORCYCLES, SNOWMOBILES AND SIMILAR VEHICLES

(76) Inventor: Luca Menghini, Magreglio (IT)

Correspondence Address: KING & SCHICKLI, PLLC, 247 NORTH BROADWAY, LEXINGTON, KY, 40507, US

(21) Appl. No.: 12/936,551

(22) PCT Filed: Apr. 6, 2009
(86) PCT No.: PCT/EP09/54087

§ 371 Date: Oct. 6, 2010

(30) Foreign Application Priority Data
Apr. 10, 2008 (IT) MI2008A000632

(51) Int. Cl. G05G 1/10

(52) U.S. Cl. 74/488

(57) ABSTRACT

An electronic throttle control device for motorcycles or other similar vehicles with two, three or four wheels, snowmobiles or the like comprising a handlebar (3) on which a rotary handle control (2) is positioned cooperating with electrical/electronic measurement means for measuring its rotation and/or angular position about the axis (W) of the handlebar (3), to hence control a usual element for modifying the vehicle engine r.p.m., i.e. to control the throttling of this latter, said means comprising, functionally rigid with the handle control (2), a first component generally defined by a rotor (12) arranged to cooperate with a second component, generally a position or angular sensor, of said means fixed on the handlebar (3). A grooved insertion piece (8) is provided rigid with the handle control (2) and arranged to cooperate torsionally with said rotor (12), between said insertion piece (8) and said rotor (12) there being a small degree of slack when the handle control is in the zero throttle position.

The present invention relates to an electronic throttle control device for motorcycles, snowmobiles and similar vehicles, in accordance with the introduction to the main claim.

Throttle control devices for a vehicle of the aforesaid type have long been known, in which the throttle control device means a device for modifying the vehicle engine r.p.m. based on its need and use. Known throttle control devices use electrical/electronic members functionally associated with a handle control positioned on the vehicle handlebar and rotating about the axis of this latter. This rotation, sensed by said members, results in variation in the engine r.p.m., as the handle control causes said members to act on a usual engine feed control element. One of these members functionally associated with the is handle control comprises a first component usually defined by a rotor, rigid with the handle control, and a second component defined by a position or angular sensor, for example a Hall sensor, rigid with the handlebar and fixed to it. Rotation of the handlebar results in consequent rotation of the rotor, this being sensed by the sensor which, by means of an electrical/electronic circuit, commands the element which modifies the engine r.p.m. (for example a throttle valve).

These known devices operate satisfactorily, but do not provide the same performance as mechanical throttle control devices with regard to the sensation felt by the driver on operating the throttle control device, i.e. on modifying the engine r.p.m. for example by accelerating. In this sense, sensation means the feeling obtained by the driver in rotating the handle control, i.e. in terms of the axial and radial slack between the handle control and handlebar present in said mechanical devices, corresponding to the loading of a spring of a throttling or carburettor element (defining the engine r.p.m. control element), and to the friction involved in the initial detachment and the sliding of the flexible mechanical transmission associated with the handle control.

Said sensation difference derives essentially from the fact that the electronic throttle controls use components requiring very narrow tolerances between the rotor and the measurement or sensor member, generally around 0.01 mm. If these tolerances are greater than said value, the excessive variation in the distance between the rotor and sensor would result in incorrect engine control.

An object of the present invention is to provide an electronic throttle control device for motorcycles, snowmobiles, seamobiles or the like, which represents an improvement over known electronic controls already present on the market.

A particular object of the present invention is to provide a throttle control is device of the aforestated type which provides the vehicle driver with sensations substantially equivalent to those encountered during the use of an analogous mechanical control device.

Another object of the present invention is to provide an electronic throttle control device which is of quick assembly and low cost.

A further object of the present invention is to provide an electronic throttle control device which provides high driver safety when, for example, because of an accident the handle control is broken with the sensor in a torsional or angular position on the handlebar such as to cause the engine accelerator to operate.

These and further objects which will be apparent to the expert of the art are attained by an electronic throttle control device in accordance with the accompanying claims.

The present invention will be more apparent from the accompanying drawings, which are provided by way of non-limiting example and in which:

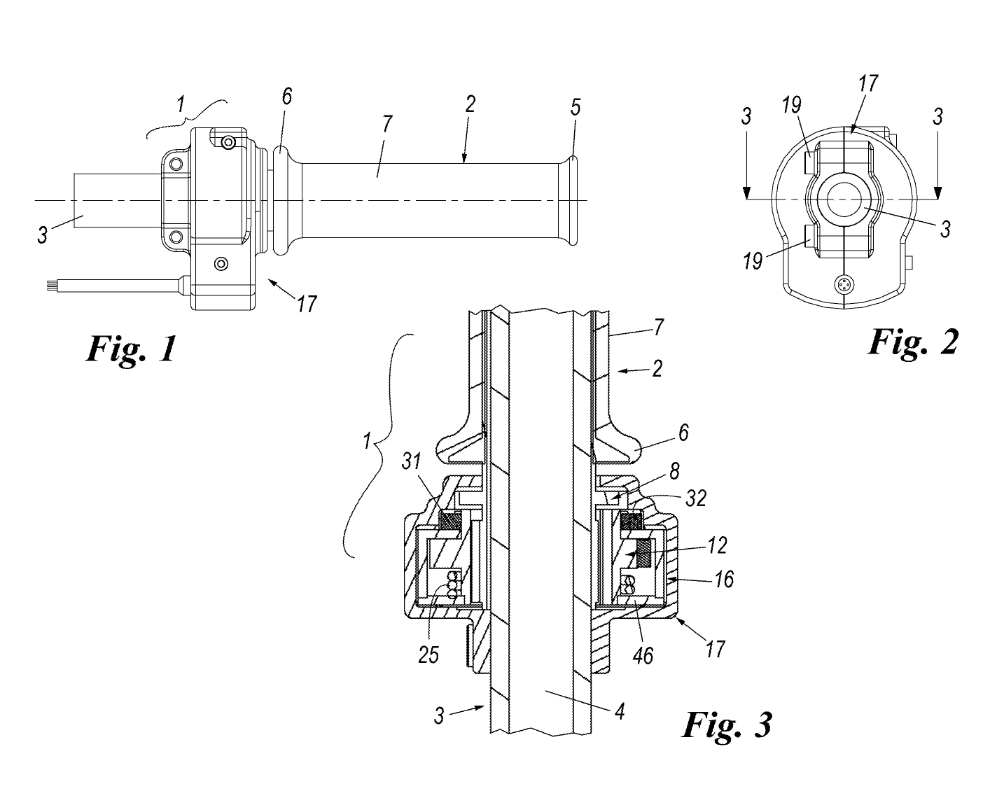

FIG. 1 is a side view of a throttle control device according to the invention;

FIG. 2 is a front view of the control device of FIG. 1;

FIG. 3 is a section on the line 3-3 of FIG. 2;

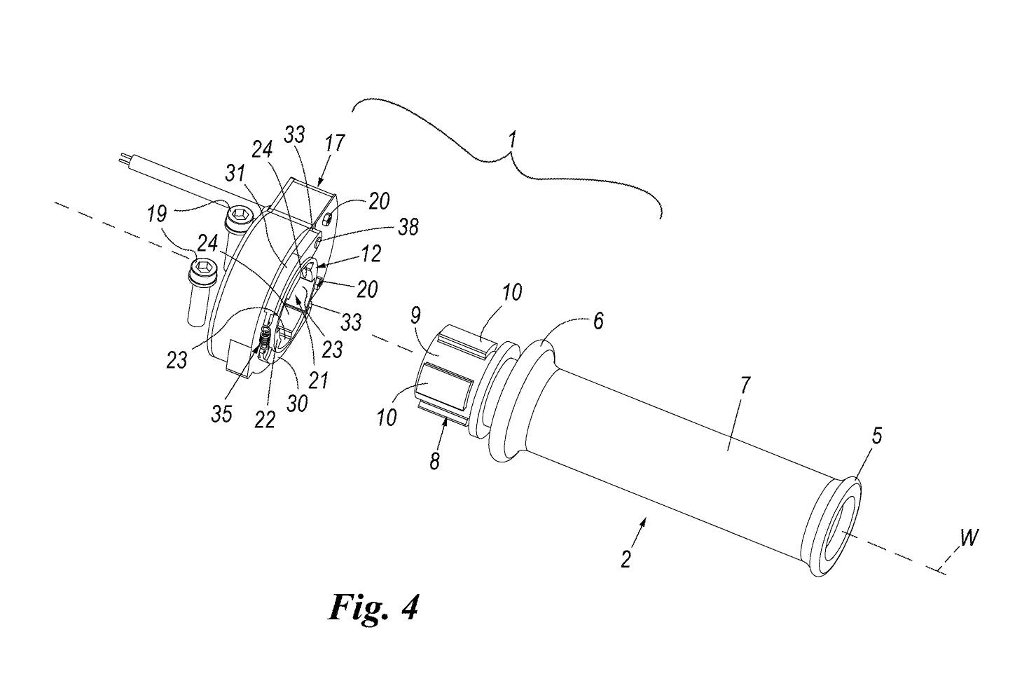

FIG. 4 is an exploded perspective view of the control device of FIG. 1; and

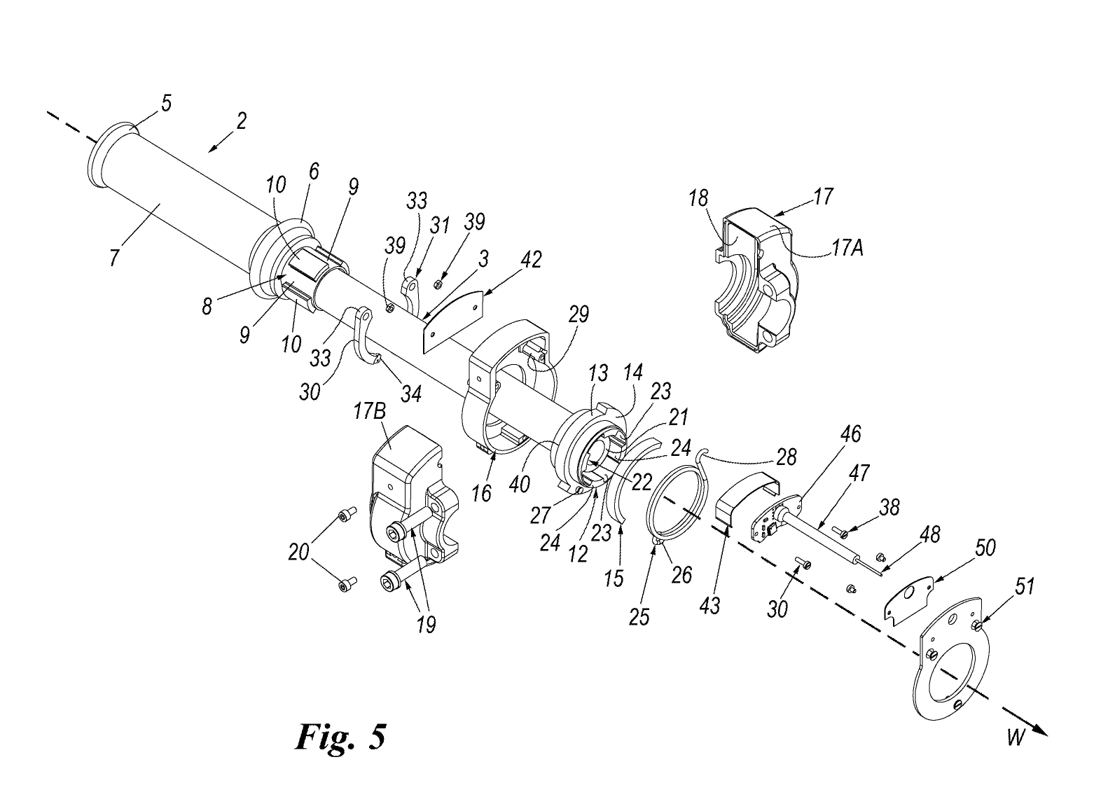

FIG. 5 is an exploded perspective view of the control device of FIG. 1 showing its component parts.

With reference to said figures, the control device of the invention is indicated overall by 1 and comprises a handle control 2 rotatably disposed on a handlebar 3 of a vehicle, for example a motorcycle. This handlebar is defined by a tubular element, hollow at 4. The handle control 2 comprises end elements 5, 6 raised above a central gripping region 7; an insertion piece 8 presenting grooves 9 spaced by projections 10 is torsionally rigid with or directly is fixed to this handle control. With this insertion piece 8 there cooperates a body 12 or rotor of substantially annular shape and supporting, within a cavity 13 provided in an external flange 14 thereof, a magnet 15 which cooperates with a measurement member or proximity sensor, for example a Hall sensor (not shown), carried by a casing 16 which is fixed by a container 17 to the handlebar 3. Specifically, this container 17 comprises two half-portions or shells 17A, 17B which are coupled together onto the handlebar 3 to each define a half cavity 18 for containing the casing 16. The two half-portions are fixed onto the handlebar by screws 19 and secured to the casing 16 by screws 20.

The rotor 12 comprises a through hole 21 enabling the rotor to be mounted on the handlebar 3. The hole is bounded by a wall 22 in which grooves 23 are present, separated from each other by projections 24, said grooves and projections being arranged to cooperate with the corresponding grooves 10 and projections 9 of said insertion piece 8, to hence become torsionally rigid with each other.

However, when the rotor 12 and the insertion piece 8 are coupled together, a degree of slack exists, although minimal, both about the axis W of the handlebar about which these are mounted (and hence an angular slack about this axis) and a longitudinal slack along this axis). This slack exists however only when the throttle control device is in the neutral position, i.e. when this latter is in the minimum position with the throttle control closed, so enabling the vehicle driver to sense exactly when acceleration commences (the moment in which the projections 10 make contact with the projections 24) and in particular when braking commences before guiding the vehicle through a bend, and the subsequent acceleration.

According to another characteristic of the invention, the rotor 12 cooperates with a spring 25 presenting a portion 26 rigid with the rotor by being is coupled to a pin 27 rising from its perimetral flange 14, said spring having another end 28 cooperating with a fixed pin 29 of the casing 16 containing the sensor. The purpose of this spring is to always reposition the rotor in a neutral position, with consequent repositioning in the neutral position of the handle control and of the insertion piece 8 associated with it. In this manner, if the handlebar breaks as the result of the vehicle falling to the ground, for example because of an accident, the spring 25 always returns the rotor 12 into this neutral position to hence close the engine throttle, hence providing considerable safety in using the vehicle.

Moreover, as the rotor 12 and the spring 25 are positioned in a fixed position when the throttle control is closed on the casing 16, it is simple to couple the spring to the rotor during assembly of the throttle control, this assembly also being facilitated by the control construction, which limits its costs.

According to a further characteristic of the invention, with the rotor 12 there cooperate a pair of brake shoes 30, 31 movable relative to the casing 16 and to the container 17 and hinged at a first end 33 to the container by bolts 38 cooperating with corresponding nuts 39. The brake shoes 30, 31 cooperate, via their second end 34, with a return spring 35 which tends to maintain it clamped onto a collar 40 of the rotor 12, which is positioned between the handle control and the rotor.

A screening plate 42 is rigid with the casing 16 and fixed to it by usual screws within the container 17, where a further screening element 43 is also disposed. This screening element protects a printed circuit card 46 positioned within the casing 16 and fixed to it in any known manner. Associated with the circuit card 46 there is a tubular element 47 in which a cavity 48 is present to transfer the throttle command to the said usual engine control element. A further cover element 50 is disposed within the casing 16 at the card 46, said is casing being finally closed on the side distant from the handle control 7 by a closure element or plate 51 fixed to the casing by screws or in any other known manner.

Hence according to the invention, the throttle control comprises various elements which mutually cooperate to on the one hand provide the driver with the sensation of a mechanical control with slack, even if this control is of electronic character, as in the present case; and on the other hand to offer the correct degree of safety to the driver for correct vehicle use, while enabling the manufacturer to provide a throttle control having a plurality of elements easily assembled together before positioning the control on the handlebar.

A particular embodiment of the invention has been described; others are however possible and are to be considered as falling within the scope of the ensuing claims.

1. An electronic throttle control device for motorcycles or other similar vehicles with two, three or four wheels, snowmobiles or similar vehicles comprising a handlebar (3) on which a rotary handle control (2) is positioned cooperating with electrical/electronic measurement means for measuring its rotation and/or angular position about the axis (W) of the handlebar (3), to hence control a usual element for modifying the vehicle engine r.p.m., i.e. to control the throttle of this latter, said means comprising a first component cooperating with the handle control, and generally defined by a rotor (12) arranged to cooperate with a second component of said means fixed on the handlebar (3), generally defined by a position or angular sensor, characterised by comprising a grooved insertion piece (8) rigid with the handle control (2) and arranged to cooperate torsionally with said rotor (12), between said insertion is piece (8) and said rotor (12) there being a small degree of slack when the handle control is in the zero throttle position.

2. A throttle control device as claimed in claim 1, characterised in that the grooved insertion piece (8) has a slack along the handlebar axis (W) relative to the rotor (12) and also an angular slack relative to this latter.

3. A throttle control device as claimed in claim 2, characterised in that said insertion piece (8) comprises a plurality of depressed portions or grooves (9) separated by projections (10), to cooperate with corresponding raised portions or projections (24) provided in an inner wall of the rotor (12) which bounds a hole (23) enabling said rotor to be mounted about the handlebar (3), the projections of the insertion piece (10) cooperating with depressed parts or grooves (23) of said rotor which are present in the inner wall between the projections (24) provided on this latter.

4. A throttle control device as claimed in claim 1, characterised in that said rotor (12) is inserted into a casing (16) containing the proximity sensor, said casing and said rotor being enclosed by an external container (17) comprising two half-shells (17A, 17B) to be coupled together about the handlebar and presenting an inner cavity (20) to receive the casing (16).

5. A throttle control device as claimed in claim 1, characterised in that said rotor comprises a perimetral flange (14) presenting a recess (13) to contain a body (15) to cooperate with said second component or position sensor or angular sensor of said measurement means.

6. A throttle control device as claimed in claim 5, characterised in that said rotor (12) cooperates with a spring (25) rigid with it and with the casing (16) containing said second component or position sensor or angular sensor, said spring having a first end (26) cooperating with said rotor (12) and a second end (28) cooperating with and fixed to the casing (16).

7. A throttle control device as claimed in claim 1, characterised in that said rotor (12) comprises a collar (40) with which a braking member (30, 31) cooperates.

8. A throttle control device as claimed in claim 7, characterised in that said braking member comprises two lever elements or shoes (30, 31) hinged to the container (17) of the casing (16) containing the second component or proximity sensor of said measurement means and urged to tighten about the collar (40) of said rotor (12) by an elastic member (35).

9. A throttle control device as claimed in claim 1, characterised in that said container (17) containing the rotor (12) and the proximity sensor also contains an electronic circuit from which a cable extends for controlling the member which modifies the vehicle engine r.p.m.
